(19) United States
(12) Patent Application Publication
(10) Pub. No.: US 2025/0265063 A1
(43) Pub. Date: Aug. 21, 2025

(54) BEHAVIOR CHANGE APPARATUS

(71) Applicant: NTT DOCOMO, INC., Tokyo (JP)

(72) Inventors: Akinari SAKAI, Chiyoda-ku (JP); Yusuke NAKAMURA, Chiyoda-ku (JP); Akira YAMADA, Chiyoda-ku (JP); Takashi SUZUKI, Chiyoda-ku (JP)

(73) Assignee: NTT DOCOMO, INC., Tokyo (JP)

(21) Appl. No.: 18/856,943

(22) PCT Filed: Mar. 24, 2023
(86) PCT No.: PCT/JP2023/011911

§ 371 Date: Oct. 15, 2024

(30) Foreign Application Priority Data
May 2, 2022 (JP) 2022-075999

(51) Int. Cl. G06F 8/61; G06N 5/022

(52) U.S. Cl. CPC G06F 8/61; G06N 5/022

(57) ABSTRACT

An objective is to prompt a user to change behavior in a virtual space. A behavior change apparatus (1) includes a mechanism decision unit (11) configured to decide a mechanism for a user in a virtual space on the basis of a cognitive bias of the user and a field installation unit (19) configured to install the mechanism decided by the mechanism decision unit (11) in the virtual space. The mechanism decision unit (11) may decide the mechanism using a prediction model for predicting a degree of change in behavior of the user from the mechanism by inputting a degree of the cognitive bias of the user. The mechanism may be a mechanism for guiding the user to predetermined content located in the virtual space. The mechanism decision unit (11) may decide the mechanism further on the basis of an attribute of the user.

### TECHNICAL FIELD

An aspect of the present disclosure relates to a behavior change apparatus for prompting a user to change behavior.

### BACKGROUND ART

In the following Patent Document 1, a furniture device that can give a user the sensation of moving in a virtual space is disclosed.

### CITATION LIST

### Patent Literature

Patent Literature 1: Japanese Patent No. 7037158

### SUMMARY OF INVENTION

### Technical Problem

However, it is difficult to prompt a user to change behavior in, for example, a virtual space, in the above-described furniture device. Therefore, there is a need for prompting a user to change behavior in a virtual space.

### Solution to Problem

According to an aspect of the present disclosure, there is provided a behavior change apparatus including: a decision unit configured to decide a mechanism for a user in a virtual space on the basis of a cognitive bias of the user; and an installation unit configured to install the mechanism decided by the decision unit in the virtual space.

In this aspect, it is possible to prompt a user to change behavior in a virtual space by installing a mechanism for the user in the virtual space.

### Advantageous Effects of Invention

According to the aspect of the present disclosure, it is possible to prompt a user to change behavior in a virtual space.

### BRIEF DESCRIPTION OF DRAWINGS

FIG. 1 A diagram showing an example of a functional configuration of a behavior change apparatus according to the embodiment.

FIG. 2 A diagram showing an example of a table of a behavior change probability of each nudge for each user.

FIG. 3 A diagram showing an example of a table of the behavior change probability of each nudge for an unknown user.

FIG. 4 A diagram showing an example of a movement mechanism based on a conformity bias.

FIG. 5 A diagram showing another example of a movement mechanism based on a conformity bias.

FIG. 6 A diagram showing an example of a movement mechanism based on decision avoidance.

FIG. 7 A diagram showing an example of a movement mechanism based on scarcity.

FIG. 8 A diagram showing an example of a movement mechanism based on a simple contact effect.

FIG. 9 A diagram showing an example of a movement mechanism based on a competitive spirit.

FIG. 10 A diagram showing an example of a table of cognitive bias information of a specific user.

FIG. 11 A diagram showing an example of a table of optimal wording information about a specific user.

FIG. 12 A diagram showing an example of a table of optimal voice information about a specific user.

FIG. 13 A diagram showing an example of a table of optimal avatar information about a specific user.

FIG. 14 A diagram showing an example of a table of optimal facial expression information about a specific user.

FIG. 15 A sequence diagram showing an example of a process executed by the behavior change apparatus according to the embodiment.

FIG. 16 A flowchart showing an example of a process executed by the behavior change apparatus according to the embodiment.

FIG. 17 A diagram showing an example of selecting an optimal mechanism based on an individual's cognitive bias.

FIG. 18 A diagram showing an example of a hardware configuration of a computer for use in the behavior change apparatus according to the embodiment.

### DESCRIPTION OF EMBODIMENTS

Hereinafter, embodiments of the present disclosure will be described in detail with reference to the accompanying drawings. In the description of the drawings, the same reference signs are used for the same elements and redundant description thereof will be omitted. Moreover, the embodiments in the present disclosure in the following description are specific examples of the present invention and the present invention is not limited to these embodiments unless otherwise specified.

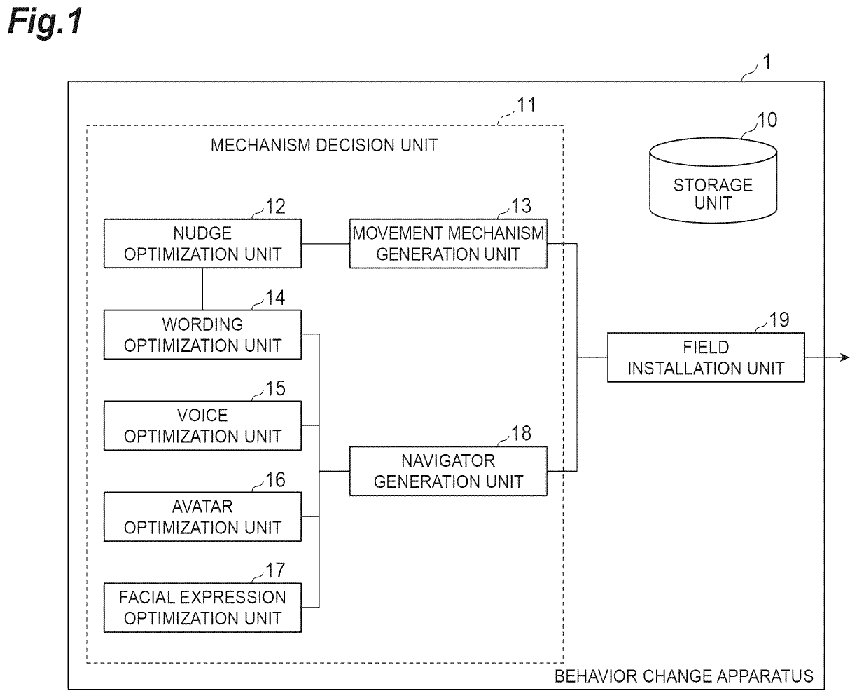

FIG. 1 is a diagram showing an example of a functional configuration of the behavior change apparatus 1 according to an embodiment.

The behavior change apparatus 1 is a computer apparatus that prompts the user to change behavior. More specifically, the behavior change apparatus 1 can provide benefits to both the user and a producer by guiding the appropriate user to appropriate content (or prompting the user to change behavior) in the virtual space.

The virtual space is a two- or three-dimensional virtual space. In addition, in the present embodiment, the term “space” may be appropriately replaced with “world.” In contrast, the term “world” may be appropriately replaced with “space.” The virtual space may be, for example, a metaverse, which is a three-dimensional space different from the real world, built on a computer or a computer network (such as the Internet).

The content includes, for example, stores, facilities, things, or information for economic activities or entertainment. In the present embodiment, the content is assumed to be located or established in a virtual space, but is not limited thereto. Because the virtual space is not restricted by a location and time, it is possible to establish various types of content compared to the real world.

As shown in FIG. 1, the behavior change apparatus 1 includes a storage unit 10, a mechanism decision unit 11 (a decision unit), and a field installation unit 19 (an installation unit). Moreover, the mechanism decision unit 11 includes a nudge optimization unit 12, a movement mechanism generation unit 13, a wording optimization unit 14, a voice optimization unit 15, an avatar optimization unit 16, a facial expression optimization unit 17, and a navigator generation unit 18.

Each functional block of the behavior change apparatus 1 is assumed to function in the behavior change apparatus 1, but is not limited thereto. For example, a part of the functional block of the behavior change apparatus 1 is a computer apparatus different from the behavior change apparatus 1 and may function while appropriately transmitting and receiving information to and from the behavior change apparatus 1 in the computer apparatus networked with the behavior change apparatus 1. Moreover, some functional blocks of the behavior change apparatus 1 may be omitted, a plurality of functional blocks may be integrated into a single functional block, or a single functional block may be separated into a plurality of functional blocks.

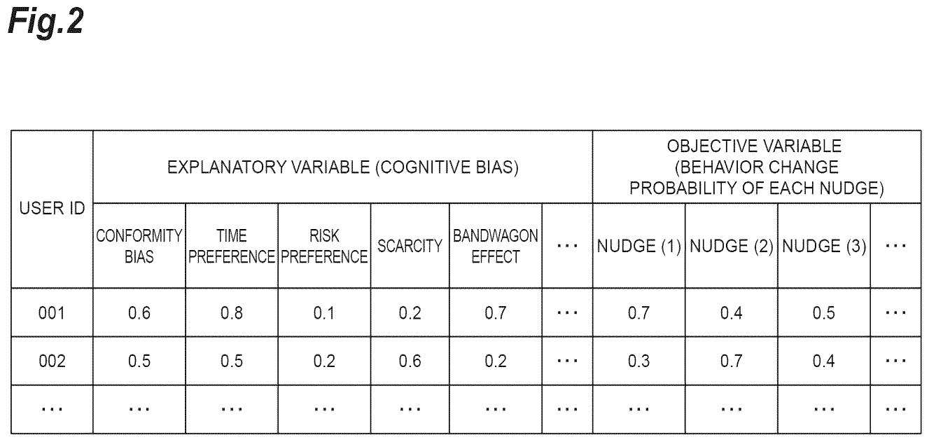

Hereinafter, each function of the behavior change apparatus 1 shown in FIG. 2 will be described.

The storage unit 10 stores any information used for calculations in the behavior change apparatus 1, calculation results in the behavior change apparatus 1, and the like. The information stored by the storage unit 10 may be appropriately referred to according to each function of the behavior change apparatus 1.

The mechanism decision unit 11 decides (or generates) a mechanism for the user in the virtual space on the basis of the user's cognitive bias. The mechanism decision unit 11 may decide one or more mechanisms (including a plurality of mechanisms) for the user in the virtual space on the basis of one or more cognitive biases (including a plurality of cognitive biases) of the user.

The cognitive bias is a psychological phenomenon in which determinations of things become illogical due to intuition or preconceived notions based on past experience or a psychological phenomenon in which people unconsciously make illogical determinations due to their assumptions, surrounding environments, and the like.

A mechanism is something devised for a purpose. The mechanism is assumed to be installed in a virtual space, but is not limited thereto. The mechanism may be a mechanism for guiding the user to predetermined content located in the virtual space.

The mechanism may comprise a mechanism related to the virtual movement of the user in the virtual space (a movement mechanism). For example, when a user-specific avatar that is an avatar for the user can be moved (in the virtual space) on the basis of the user's instruction in the virtual space, the mechanism is a mechanism that affects the movement or a mechanism that provides movement guidance.

The mechanism may comprise a mechanism (a navigator) related to the guidance for the user by a guiding avatar that is a predetermined avatar in the virtual space. The guiding avatar is an avatar for guiding the user and an avatar different from the user-specific avatar is assumed, but is not limited thereto. At least one item of the wording (message content and a way of conveying) emitted by the guiding avatar during guidance, the voice (a frequency, intensity, volume, and intonation) emitted by the guiding avatar during guidance, the appearance of the guiding avatar, or the facial expression of the guiding avatar during guidance may be based on the cognitive bias of the user.

The mechanism decision unit 11 may output mechanism information about the decided mechanism to the field installation unit 19 or the storage unit 10 may store the mechanism information.

The mechanism decision unit 11 may acquire cognitive bias information about the user's cognitive bias and decide mechanism information about the mechanism for the user in the virtual space on the basis of the acquired cognitive bias information. A timing at which the mechanism decision unit 11 acquires the cognitive bias information may be a timing based on an instruction of any person such as an administrator or a user of the behavior change apparatus 1 or may be periodic (e.g., once an hour). The mechanism decision unit 11 may acquire cognitive bias information stored in advance from the storage unit 10 or may acquire the cognitive bias information from another apparatus via a network. The mechanism decision unit 11 may extract mechanism information associated with the acquired cognitive bias information with reference to information which is stored in advance by the storage unit 10 and in which the cognitive bias information and the mechanism information are associated and decide the extracted mechanism information as the finally decided mechanism information (mechanism).

The mechanism decision unit 11 may extract wording information associated with the acquired cognitive bias information with reference to information which is stored in advance by the storage unit 10 and in which the cognitive bias information and the wording information about wording emitted by the guiding avatar during guidance are associated and decide the extracted wording information as the finally decided wording information (wording emitted by the guiding avatar during guidance).

The mechanism decision unit 11 may extract voice information associated with the acquired cognitive bias information with reference to information which is stored in advance by the storage unit 10 and in which the cognitive bias information and the voice information about voice emitted by the guiding avatar during guidance are associated and decide the extracted voice information as the finally decided wording information (voice emitted by the guiding avatar during guidance).

The mechanism decision unit 11 may extract appearance information associated with the acquired cognitive bias information with reference to information which is stored in advance by the storage unit 10 and in which the cognitive bias information and the appearance information about the appearance of the guiding avatar are associated and decide the extracted appearance information as the finally decided appearance information (the appearance of the guiding avatar).

The mechanism decision unit 11 may extract facial expression information associated with the acquired cognitive bias information with reference to information which is stored in advance by the storage unit 10 and in which the cognitive bias information and the facial expression information about the facial expression of the guiding avatar during guidance are associated and decide the extracted facial expression information as the finally decided facial expression information (the facial expression of the guiding avatar during guidance).

The mechanism decision unit 11 may decide a nudge for the user on the basis of the user's cognitive bias and may decide a mechanism for the user in the virtual space on the basis of the decided nudge.

A nudge is a mechanism or environmental change for prompting the user to voluntarily select desired behavior instead of enforcement or a mechanism or environmental change for gently making the user aware and unconsciously or reflexively guiding the user in an appropriate direction.

More specifically, the mechanism decision unit 11 may acquire cognitive bias information about the user's cognitive bias, decide nudge information about the nudge for the user on the basis of the acquired cognitive bias information, and decide mechanism information about the mechanism for the user in the virtual space on the basis of the decided nudge information. The mechanism decision unit 11 may extract nudge information associated with the acquired cognitive bias information with reference to the information which is stored in advance by the storage unit 10 and in which the cognitive bias information and the nudge information are associated, extract mechanism information associated with the extracted nudge information with reference to the information which is stored in advance by the storage unit 10 and in which the nudge information and the mechanism information are associated, and decide the extracted mechanism information as the final decided mechanism information (mechanism).

The mechanism decision unit 11 may decide the mechanism using a prediction model for predicting a degree of change in behavior of the user based on the mechanism by inputting a degree of the cognitive bias of the user. The degree of the cognitive bias is, for example, a real number from “0” to “1.” The degree (tendency) may be lower when the real number is closer to “0” and higher when the real number is closer to “1.” Likewise, the degree of change in behavior is, for example, a real number of “0” to “1.” The degree (tendency) may be lower when the real number is closer to “0” and higher when the real number is closer to “1.” The prediction model may be, for example, a trained model generated by machine learning or a mathematical model. The mechanism decision unit 11, for example, may decide a mechanism of the highest degree of change among degrees of change in the behavior of the user based on a mechanism predicted by inputting the degree of the cognitive bias of the user to the prediction model or may decide N higher-level mechanisms (N is an integer of 1 or more).

The mechanism decision unit 11 may decide the mechanism further on the basis of the user's attributes. The attributes are, for example, gender, age, and the like. That is, the mechanism decision unit 11 may decide a mechanism for the user in the virtual space on the basis of the user's cognitive bias and the user's attributes. The mechanism decision unit 11 may decide one or more mechanisms (including a plurality of mechanisms) for the user in the virtual space on the basis of one or more cognitive biases (including a plurality of cognitive biases) of the user and one or more attributes (including a plurality of attributes) of the user.

The mechanism decision unit 11 may acquire cognitive bias information about the user's cognitive bias and attribute information about the user's attributes and decide mechanism information about the mechanism for the user in the virtual space on the basis of the acquired cognitive bias information and the acquired attribute information. The mechanism decision unit 11 may acquire the cognitive bias information and the attribute information stored in advance from the storage unit 10 or may acquire the cognitive bias information and the attribute information from another apparatus via a network. The mechanism decision unit 11 may extract mechanism information associated with the acquired cognitive bias information and the acquired attribute information with reference to information which is stored in advance by the storage unit 10 and in which the cognitive bias information, the attribute information, and the mechanism information are associated and decide the extracted mechanism information as the finally decided mechanism information (mechanism).

The mechanism decision unit 11 is configured to include a nudge optimization unit 12, a movement mechanism generation unit 13, a wording optimization unit 14, a voice optimization unit 15, an avatar optimization unit 16, a facial expression optimization unit 17, and a navigator generation unit 18.

The nudge optimization unit 12 decides an optimal nudge for the user on the basis of the user's cognitive bias. The optimal nudge is a nudge having the highest effect on the user or a nudge having an effect on the user satisfying a predetermined criterion. The nudge optimization unit 12 may decide one or more nudges suitable for the user on the basis of one or more cognitive biases of the user. A suitable nudge is a nudge having an effect on the user satisfying a predetermined criterion. The nudge optimization unit 12 may decide one or more nudges suitable for the user on the basis of one or more cognitive biases of the user and one or more attributes of the user. The nudge optimization unit 12 may output nudge information about the decided nudge to the movement mechanism generation unit 13 and the wording optimization unit 14 or the storage unit 10 may store the nudge information.

The nudge optimization unit 12 may acquire and use a behavior change probability (a probability of a change in behavior) of a nudge of each user stored in advance by the storage unit 10.

FIG. 2 is a diagram showing an example of a table of the behavior change probability of each nudge for each user. In the example of the table of FIG. 2, a user ID for identifying a user, a degree of conformity bias that is a cognitive bias of the user, a degree of time preference that is the cognitive bias of the user, a degree of risk preference that is the cognitive bias of the user, a degree of scarcity that is the cognitive bias of the user, a degree of bandwagon effect that is the cognitive bias of the user, a degree of any other cognitive bias of the user, a behavior change probability of the user in nudge (1) which is a predetermined nudge, a behavior change probability of the user in nudge (2) which is a predetermined nudge, a behavior change probability of the user in nudge (3) which is a predetermined nudge, and a behavior change probability of the user in any other predetermined nudge are associated. The behavior change probability is, for example, a real number from “0” to “1.” The behavior change probability (tendency) may be lower when the real number is closer to “0” and higher when the real number is closer to “1.”

In FIG. 2, the cognitive bias is used as an explanatory variable, the behavior change probability of each nudge is used as an objective variable, and the behavior change apparatus 1 may be trained to estimate the behavior change probability of each nudge from the cognitive bias. An intervention is made in random nudges for learning. As a result of learning, a prediction model may be generated. As a learning result of the behavior change apparatus 1, the nudge optimization unit 12 may predict the behavior change probability of each nudge using a cognitive bias as an input to an unknown user. The nudge optimization unit 12 may decide (select) a nudge that can be expected to have the most effect (a large prediction value).

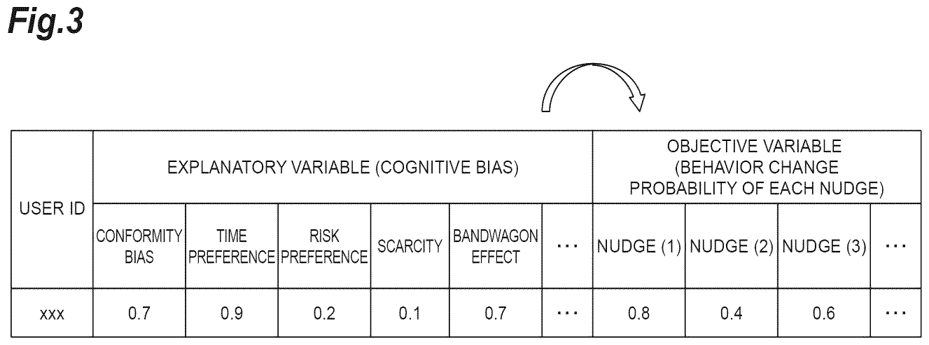

FIG. 3 is a diagram showing an example of a table of the behavior change probability of each nudge for an unknown user. In the example of the table of FIG. 3, a user ID for identifying a (unknown) user, a degree of conformity bias of the user, a degree of time preference of the user, a degree of risk preference of the user, a degree of scarcity of the user, a degree of bandwagon effect of the user, a degree of any other cognitive bias of the user, a behavior change probability of the user in nudge (1), a behavior change probability of the user in nudge (2), a behavior change probability of the user in nudge (3), and a behavior change probability of the user in any other predetermined nudge are associated. For example, the nudge optimization unit 12 may acquire the behavior change probability of the user in nudge (1), the behavior change probability of the user in nudge (2), the behavior change probability of the user in nudge (3), and the behavior change probability of the user in any other predetermined nudge output by inputting the degree of conformity bias of the user, the degree of time preference of the user, the degree of risk preference of the user, the degree of scarcity of the user, the degree of bandwagon effect of the user, and the degree of any other cognitive bias of the user to the prediction model and decide a nudge optimal for the user on the basis of the acquired behavior change probabilities.

An example of learning for the nudge optimization unit 12 to decide (estimate) the optimal nudge for the user will be described. The behavior change apparatus 1 randomly intervenes in an unspecified number of users with “nudges linked to a conformity bias,” “nudges linked to scarcity,” and “nudges linked to a simple contact effect” for data collection. As a result, for example, it is assumed that data in which nudges linked to a conformity bias in the 20s, nudges linked to scarcity in the 30s to 40s, and nudges linked to the simple contact effect in the 50s and older are valid is collected (a tendency difference appears in nudges effective according to an attribute and cognitive bias). By learning these data items with a machine learning model, it is possible to create a model in which an estimate of the nudge linked to the conformity bias is larger for people in their 20s and an estimate of the nudge linked to the simple contact effect is larger for those in their 50s and older. That is, it is possible to decide (select) an optimal (suitable) nudge for an unknown user. In addition, in the present embodiment, a general machine learning method is used for learning.

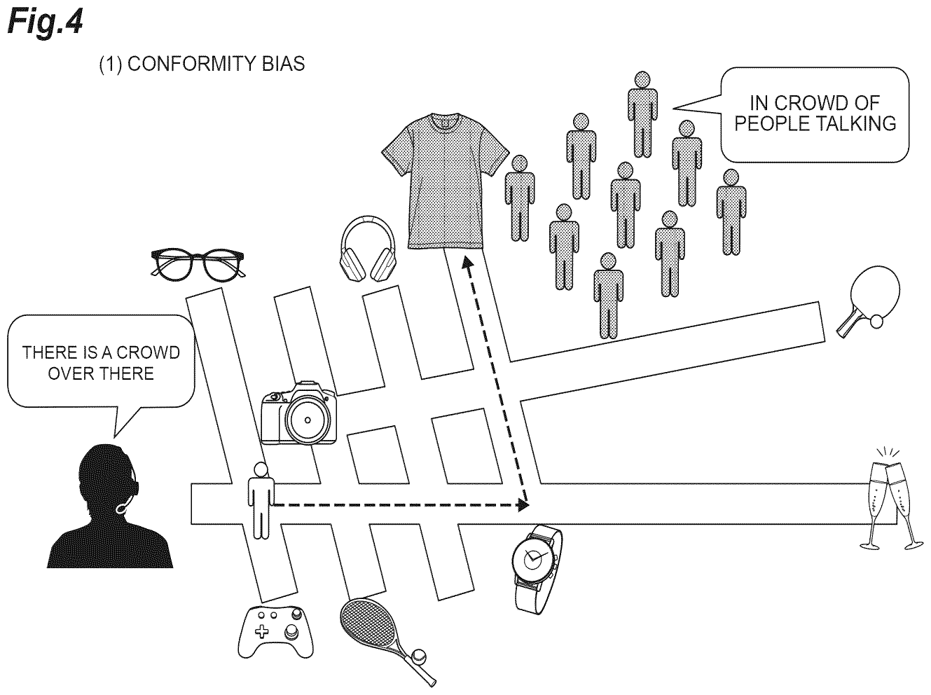

The nudge optimization unit 12 may input at least one item of attribute information stored in advance by the storage unit 10 and a score for each cognitive bias stored in advance by the storage unit 10. The nudge optimization unit 12 may estimate the efficacy (0% to 100%) of each nudge within a nudge preset (nudge (1), nudge (2), nudge (3), and the like) from the input data and select the most effective nudge. For example, when a certain user estimates nudge (1) of 70%, nudge (2) of 50%, and nudge (3) of 40%, the user selects nudge (1) because it can be said that nudge (1) is the most effective. In addition, the preset is, for example, a nudge linked to a conformity bias and the like (see FIGS. 4 to 9 to be described below). The nudge optimization unit 12 may output nudge information about the most effective nudge selected from the nudge preset to the movement mechanism generation unit 13 and the wording optimization unit 14 and the storage unit 10 may store the nudge information.

The movement mechanism generation unit 13 generates a movement mechanism on the basis of the nudge decided by the nudge optimization unit 12. More specifically, the movement mechanism generation unit 13 extracts movement mechanism information associated with the nudge information input from the nudge optimization unit 12 with reference to information which is stored in advance by the storage unit 10 and in which the nudge information and the movement mechanism information about the movement mechanism are associated and generates a movement mechanism indicated in the extracted movement mechanism information (in the virtual space). The movement mechanism generation unit 13 may output information indicating that the movement mechanism has been generated or information about the generated movement mechanism to the field installation unit 19 or the storage unit 10 may store the information.

A specific example of a movement mechanism generated by the movement mechanism generation unit 13 will be described with reference to FIGS. 4 to 9.

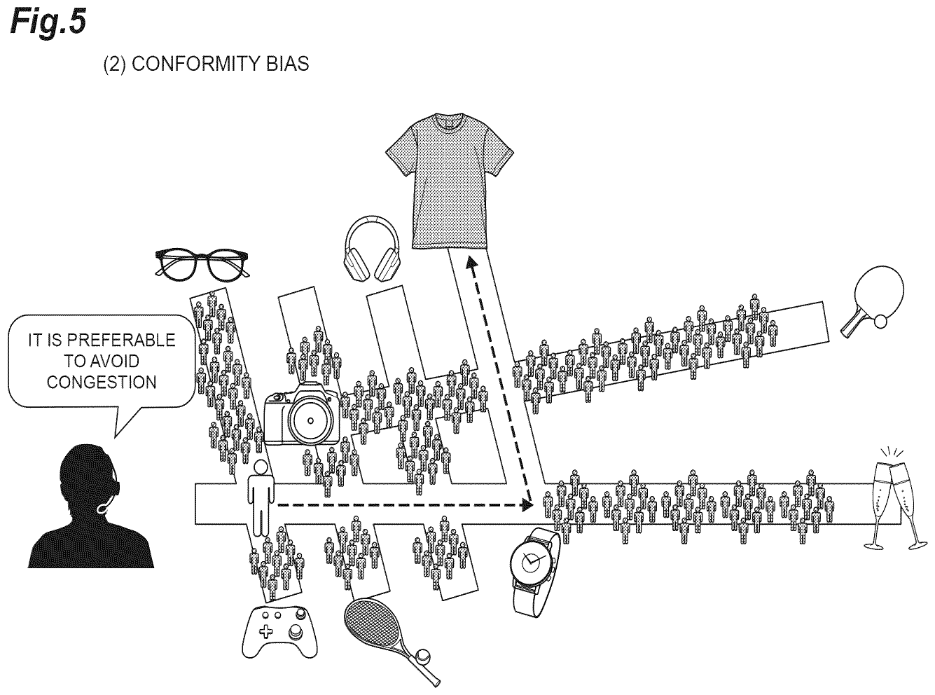

FIG. 4 is a diagram showing an example of a movement mechanism based on conformity bias. (Like FIGS. 5 to 9,) FIG. 4 is a diagram showing a virtual space. In the virtual space, there is a route along which the user can move and content icons corresponding to various types of contents are arranged in the middle or end of the route. The user-specific avatar is indicated by an icon in the shape of a person's whole body. The user can consume content corresponding to the content icon by moving the user-specific avatar to a position of the content icon. FIGS. 4 to 9 are examples and the present invention is not limited thereto. For example, the arrangement of the content icon is not essential and the content icon may not be arranged when a type of content is known in another display form or the like.

In FIG. 4, it is assumed that a user who has a tendency of a conformity bias as a cognitive bias is guided to T-shirt content, which is content shown in the form of a T-shirt. In this case, the movement mechanism generation unit 13 (and the field installation unit 19 to be described below) generates and installs a non-player character (NPC) group around an icon of the T-shirt content to which the user is guided, and therefore the user moves to the T-shirt content. Furthermore, the guiding avatar generated by the navigator generation unit 18 to be described below may guide the user to the T-shirt icon by saying or displaying a message that “There is a crowd over there.”

FIG. 5 is a diagram showing another example of a movement mechanism based on a conformity bias. In FIG. 5, it is assumed that a user who does not have a tendency to the conformity bias to the T-shirt content is guided. In this case, the movement mechanism generation unit 13 (and the field installation unit 19 to be described below) prompts the user to avoid congestion by generating and installing a group NPC on a route other than a route desired to be used. Furthermore, the guiding avatar generated by the navigator generation unit 18 to be described below may guide the user to the T-shirt icon by saying or displaying a message that “It is preferable to avoid congestion.”

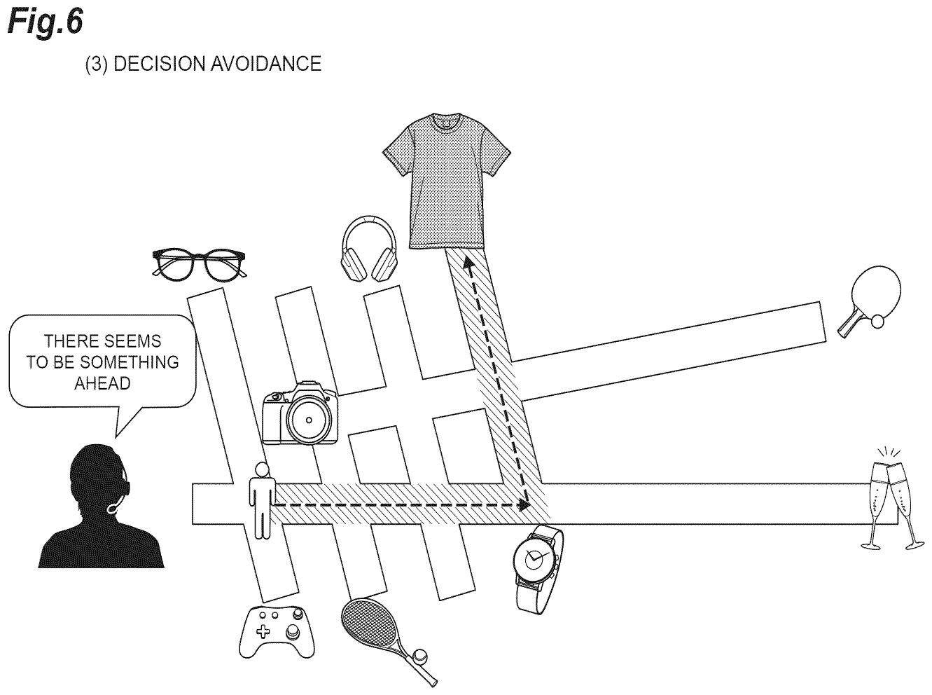

FIG. 6 is a diagram showing an example of a movement mechanism based on decision avoidance. In FIG. 6, it is assumed that users who have a tendency to avoid decisions as a cognitive bias are guided in T-shirt content. In this case, the movement mechanism generation unit 13 (and the field installation unit 19 to be described below) narrows the user's options and guides the user by performing a generation and arrangement process such as a process of making a specific route conspicuous. Furthermore, the guiding avatar generated by the navigator generation unit 18 to be described below may guide the user to a T-shirt icon by saying or displaying a message that “There seems to be something ahead.”

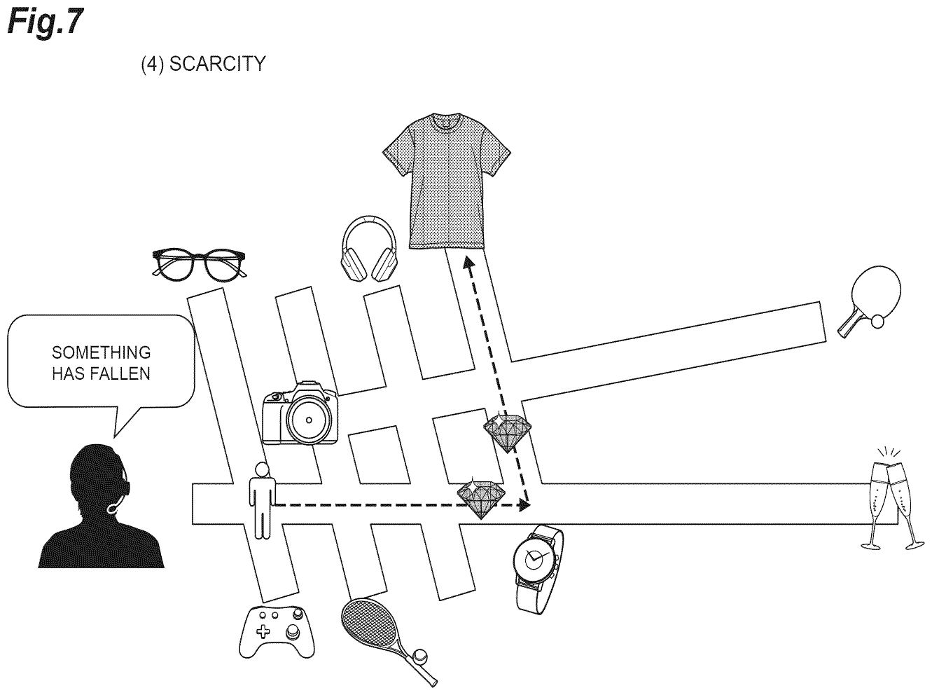

FIG. 7 is a diagram showing an example of a movement mechanism based on scarcity. In FIG. 7, it is assumed that a user who has a cognitive bias toward scarcity in T-shirt content is guided. In this case, the movement mechanism generation unit 13 (and the field installation unit 19 to be described below) guides the user by installing and generating a highly rare (user-interested) item (a gem in FIG. 7) on a route guideline. A route (road) that makes a sound during walking or the like may be generated and installed instead of the item. Furthermore, the user may be guided to the T-shirt icon when the guiding avatar generated by the navigator generation unit 18 to be described below says or displays a message that “Something has fallen.”

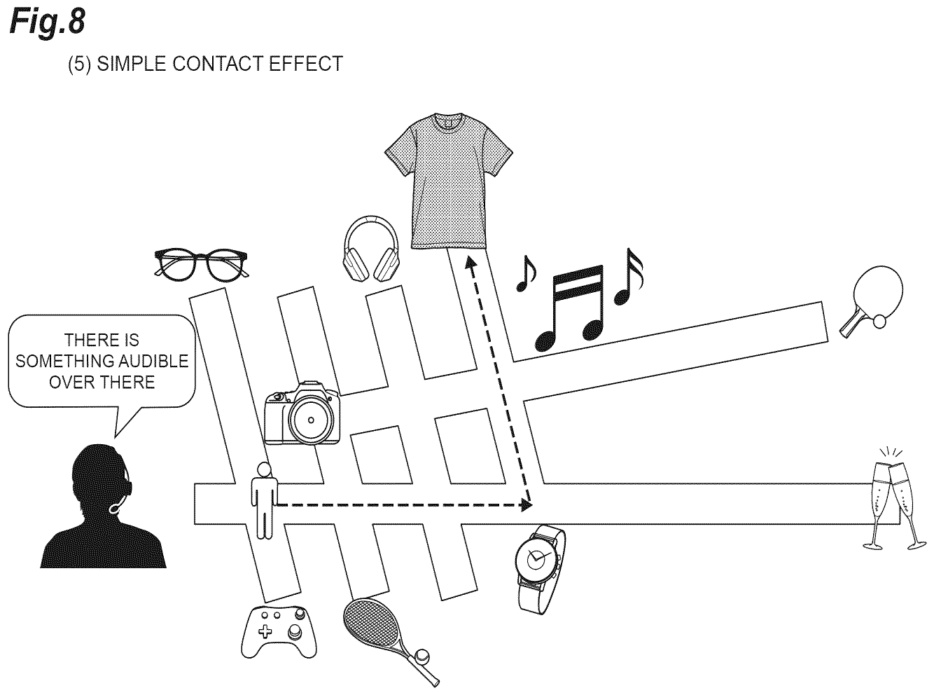

FIG. 8 is a diagram showing an example of a movement mechanism based on a simple contact effect. In FIG. 8, it is assumed that a user who tends to have a simple contact effect as a cognitive bias in T-shirt content is guided. In this case, the movement mechanism generation unit 13 (and the field installation unit 19 to be described below) guides the user by generating and arranging directional music familiar to the user to flow around the T-shirt content. Furthermore, the user may be guided to the T-shirt icon when the guiding avatar generated by the navigator generation unit 18 to be described below says or displays a message that “There is something audible over there.”

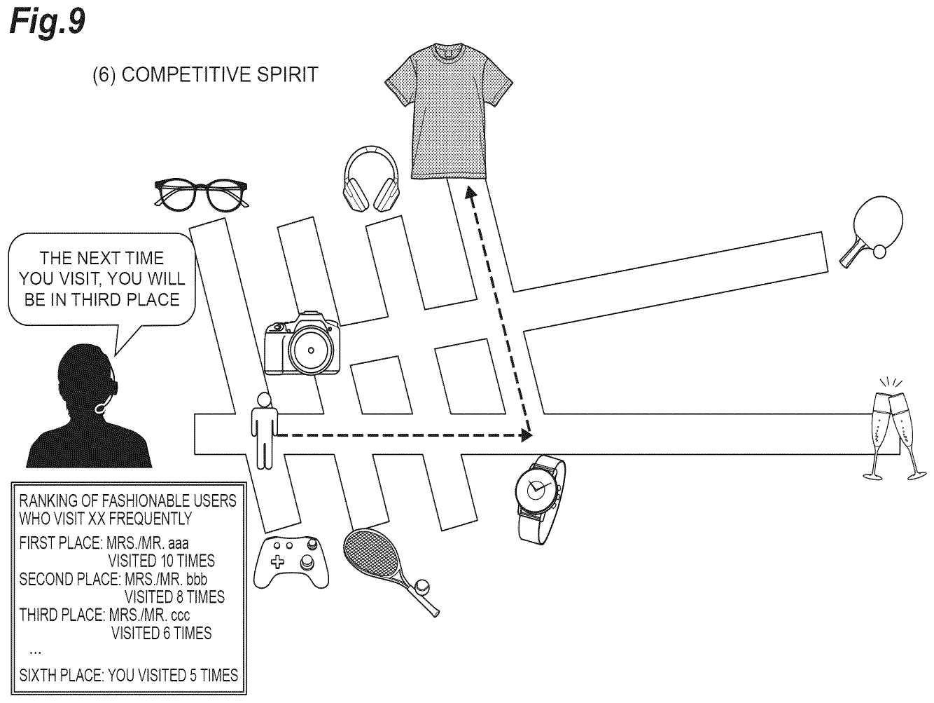

FIG. 9 is a diagram showing an example of a movement mechanism based on a competitive spirit. In FIG. 9, it is assumed that a user who tends to be competitive as a cognitive bias in T-shirt content is guided. In this case, the movement mechanism generation unit 13 (and the field installation unit 19 to be described below) generates and arranges a score in the game or a score such as the number of visits or the number of steps to provide visualization including those of others (other users), thereby fostering a competitive spirit of the user and guiding the user. Furthermore, the guiding avatar generated by the navigator generation unit 18 to be described below may guide the user to the T-shirt icon by saying or displaying a message that “The next time you visit, you will be in third place.”

The wording optimization unit 14 decides the optimal wording for the user based on the user's cognitive bias. The optimal wording is wording having the highest effect on the user or having an effect on the user satisfying a predetermined criterion. The wording optimization unit 14 may decide one or more words suitable for the user on the basis of one or more cognitive biases of the user. Suitable wording is wording having an effect on the user satisfying a predetermined criterion. The wording optimization unit 14 may decide one or more wordings suitable for the user on the basis of one or more cognitive biases of the user and one or more attributes of the user. The wording optimization unit 14 may output wording information about the decided wording to the navigator generation unit 18 or the storage unit 10 may store the wording information.

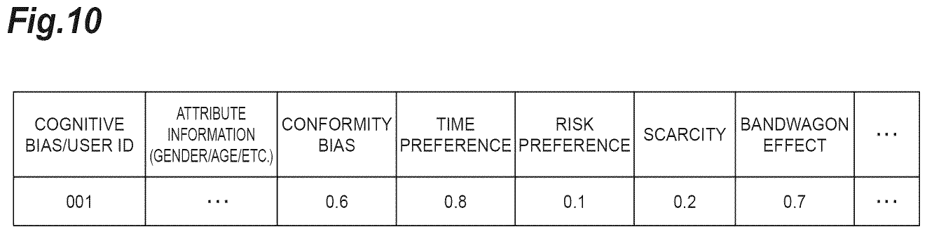

FIG. 10 is a diagram showing an example of a table of cognitive bias information of a specific user. In the example of the table shown in FIG. 10, a user ID for identifying the user, attribute information about the user's attributes (gender, age, and the like), a degree of conformity bias that is the user's cognitive bias, a degree of time preference that is the user's cognitive bias, a degree of risk preference that is the user's cognitive bias, a degree of scarcity that is the user's cognitive bias, a degree of bandwagon effect that is the user's cognitive bias, and a degree of any other cognitive bias of the user are associated. The wording optimization unit 14 may decide the optimal wording for the user on the basis of the user's cognitive bias information as shown in FIG. 10.

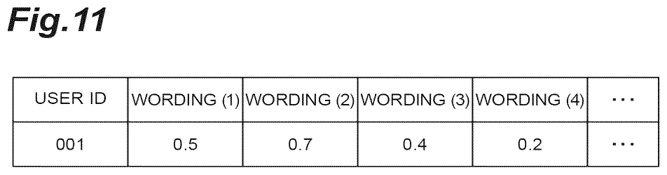

FIG. 11 is a diagram showing an example of a table of optimal wording information about a specific user. In the table example shown in FIG. 11, a user ID for identifying the user, a behavior change probability of predetermined wording (1), a behavior change probability of predetermined wording (2), a behavior change probability of predetermined wording (3), a behavior change probability of predetermined wording (4), and a behavior change probability of other predetermined wording are associated. Here, the predetermined wording is a preset for each type of nudge. For example, wording (1) is a preset for nudge (1), wording (2) is a preset for nudge (2), wording (3) is a preset for nudge (3), and wording (4) is a preset for nudge (4). The wording optimization unit 14 may decide the optimal wording for a particular user on the basis of the optimal wording information about the specific user as shown in FIG. 11.

The wording optimization unit 14 includes at least one item of attribute information stored in advance by the storage unit 10, nudge information input from the nudge optimization unit 12 (or stored in advance by the storage unit 10), and a score of each cognitive bias stored in advance by the storage unit 10. The wording optimization unit 14 may first acquire a preset of the wording associated with the optimal nudge from the optimal nudge. The efficacy (0% to 100%) of wording from a wording preset (wording (1), wording (2), wording (3), or the like) is estimated from the input data and the most effective wording is decided (selected). For example, wording (1) of 70%, wording (2) of 50%, and wording (3) of 40% are estimated for a certain user, because the user can say that wording (1) is the most effective, wording (1) is decided. In addition, the preset is, for example, “There is a crowd over there,” “The crowd over there is at a store that's popular on SNS,” or the like (in the case of FIG. 4). The wording optimization unit 14 may output wording information about the decided wording (the most effective wording selected from the wording preset) to the navigator generation unit 18 or the storage unit 10 may store the wording information.

The voice optimization unit 15 decides the optimal voice for the user on the basis of the user's cognitive bias. The optimal voice is voice having the highest effect on the user or having an effect on the user satisfying a predetermined criterion. The voice optimization unit 15 may decide one or more voices suitable for the user on the basis of one or more cognitive biases of the user. Suitable voice is voice having an effect on the user satisfying a predetermined criterion. The voice optimization unit 15 may decide one or more voices suitable for the user on the basis of one or more cognitive biases of the user and one or more attributes of the user. The voice optimization unit 15 may output voice information about the decided voice to the navigator generation unit 18 or the storage unit 10 may store the voice information.

The voice optimization unit 15 may decide the optimal voice for the user on the basis of the user's cognitive bias information as shown in FIG. 10.

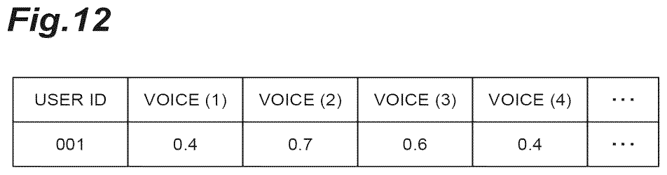

FIG. 12 is a diagram showing an example of a table of optimal voice information about a specific user. In the example of the table shown in FIG. 12, a user ID for identifying the user, a behavior change probability of voice (1) that is predetermined voice, a behavior change probability of voice (2) that is predetermined voice, a behavior change probability of voice (3) that is predetermined voice, a behavior change probability of voice (4) that is predetermined voice, and a behavior change probability of other predetermined voice are associated. The voice optimization unit 15 may decide the optimal voice for the user on the basis of the optimal voice information about the specific user as shown in FIG. 12.

The voice optimization unit 15 may input at least one item of attribute information stored in advance by the storage unit 10 and a score of each cognitive bias stored in advance by the storage unit 10. The voice optimization unit 15 may provide a voice preset (voice (1), voice (2), voice (3), and the like), estimate the efficacy (0% to 100%) of voice from the input data, and decide (select) the most effective voice. For example, when voice (1) of 70%, voice (2) of 50%, and voice (3) of 40% have been estimated for the certain user, the user can say that voice (1) is the most effective, such that voice (1) is decided. In addition, in the preset, for example, the voice is fast at a high frequency, fast at a low frequency, slow at a high frequency, slow at a low frequency, or the like. The voice optimization unit 15 may output voice information about the decided voice (the most effective voice selected from the voice preset) to the navigator generation unit 18 or the storage unit 10 may store the voice information.

The avatar optimization unit 16 decides the optimal guiding avatar (appearance) for the user on the basis of the user's cognitive bias. The optimal guiding avatar is a guiding avatar having the highest effect on the user or having an effect on the user satisfying a predetermined criterion. The avatar optimization unit 16 may decide one or more guiding avatars suitable for the user on the basis of one or more cognitive biases of the user. A suitable guiding avatar is a guiding avatar having an effect on the user satisfying a predetermined criterion. The avatar optimization unit 16 may decide one or more guiding avatars suitable for the user on the basis of one or more cognitive biases of the user and one or more attributes of the user. The avatar optimization unit 16 may output the guiding avatar information about the decided guiding avatar to the navigator generation unit 18 or the storage unit 10 may store the guiding avatar information.

The avatar optimization unit 16 may decide the optimal guiding avatar for the user on the basis of the user's cognitive bias information as shown in FIG. 10.

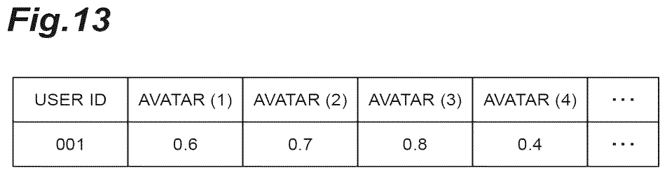

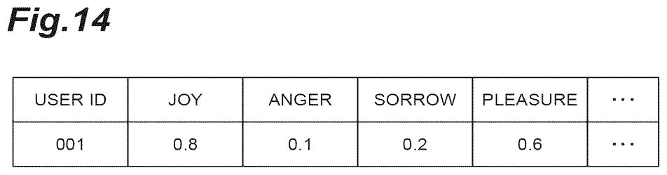

FIG. 13 is a diagram showing an example of a table of optimal avatar information about a specific user. In the example of the table shown in FIG. 14, a user ID for identifying the user, a behavior change probability of avatar (1) that is a predetermined guiding avatar, a behavior change probability of avatar (2) that is a predetermined guiding avatar, a behavior change probability of guiding avatar (3) that is a predetermined avatar, a behavior change probability of guiding avatar (4) that is a predetermined avatar, and a behavior change probability of any other predetermined avatar are associated. The avatar optimization unit 16 may decide the optimal guiding avatar for the user on the basis of the optimal avatar information about the specific user as shown in FIG. 13.

The avatar optimization unit 16 may input at least one item of attribute information stored in advance by the storage unit 10 and a score of each cognitive bias stored in advance by the storage unit 10. The avatar optimization unit 16 may provide a guiding avatar preset of (avatar (1), avatar (2), avatar (3), and the like), estimate the efficacy (0% to 100%) of each guiding avatar from the input data, and decide (select) the most effective guiding avatar. For example, when avatar (1) of 70%, avatar (2) of 50%, and avatar (3) of 40% have been estimated for the certain user, the user can say that avatar (1) is the most effective, such that avatar (1) is decided. In addition, the preset includes, for example, long hair for men, long hair for women, short hair for men, short hair for women, elderly men, elderly women, and the like. The avatar optimization unit 16 may output the guiding avatar information about the decided guiding avatar (the most effective guiding avatar selected from the guiding avatar preset) to the navigator generation unit 18 or the storage unit 10 may store the guiding avatar information.

The facial expression optimization unit 17 decides a facial expression of the optimal guiding avatar for the user (hereinafter simply referred to as a “facial expression”) on the basis of the user's cognitive bias. The optimal facial expression is a facial expression having the highest effect on the user or having an effect on the user satisfying a predetermined criterion. The facial expression optimization unit 17 may decide one or more facial expressions suitable for the user on the basis of one or more cognitive biases of the user. A suitable facial expression is a facial expression having an effect on the user satisfying a predetermined criterion. The facial expression optimization unit 17 may decide one or more facial expressions suitable for the user on the basis of one or more cognitive biases of the user and one or more attributes of the user. The facial expression optimization unit 17 may output facial expression information about the decided facial expression to the navigator generation unit 18 or the storage unit 10 may store the facial expression information.

The facial expression optimization unit 17 may decide an optimal facial expression for the user on the basis of the user's cognitive bias information as shown in FIG. 10.

FIG. 14 is a diagram showing an example of a table of optimal facial expression information about a specific user. In the example of the table shown in FIG. 14, a user ID for identifying the user, a behavior change probability of joy that is a predetermined facial expression, a behavior change probability of anger that is a predetermined facial expression, a behavior change probability of sorrow that is a predetermined facial expression, a behavior change probability of pleasure that is a predetermined facial expression, and a behavior change probability of any other predetermined facial expression are associated. The facial expression optimization unit 17 may decide the optimal facial expression for the user on the basis of the optimal facial expression information about the specific user as shown in FIG. 14.

The facial expression optimization unit 17 may input at least one item of the attribute information stored in advance by the storage unit 10 and the score of each cognitive bias stored in advance by the storage unit 10. The facial expression optimization unit 17 may provide a preset of facial expressions (joy, anger, sorrow, and the like), estimate the efficacy (0% to 100%) from the input data for each facial expression, and decide (select) the most effective facial expression. For example, when a joy of 70%, an anger of 50%, and a sorrow of 40% have been estimated for the certain user, the user selects the pleasure because it can be said that the pleasure is the most effective. In addition, the preset includes, for example, joy, anger, sorrow, pleasure, and the like. The facial expression optimization unit 17 may output facial expression information about the decided facial expression (the most effective facial expression selected from the facial expression preset) to the navigator generation unit 18 or the storage unit 10 may store the facial expression information.

The navigator generation unit 18 generates a navigator (a mechanism) (in the virtual space) on the basis of wording information decided (input) by the wording optimization unit 14, voice information decided (input) by the voice optimization unit 15, guiding avatar information decided (input) by the avatar optimization unit 16, and facial expression information decided by the facial expression optimization unit 17. The navigator is a guide for guiding the user. The navigator may utter wording indicated in wording information by voice indicated in voice information with the appearance of the guiding avatar indicated in the guiding avatar information and the facial expression indicated in the facial expression information. That is, the navigator utters optimal wording with the optimal facial expression at the optimal avatar (appearance) for the user by optimal voice. The navigator generation unit 18 may output information indicating that the navigator has been generated or information about the generated navigator to the field installation unit 19 or the storage unit 10 may store the information.

The field installation unit 19 installs a mechanism decided by the mechanism decision unit 11 in the virtual space (field). More specifically, the field installation unit 19 installs a movement mechanism generated (decided) by the movement mechanism generation unit 13 and a navigator generated (decided) by the navigator generation unit 18 in the virtual space. The field installation unit 19 may install a movement mechanism generated by the movement mechanism generation unit 13 (a movement mechanism indicated in information about the generated movement mechanism input from the movement mechanism generation unit 13) in the virtual space at a timing when information indicating that the movement mechanism has been generated from the movement mechanism generation unit 13 has been input. The field installation unit 19 may install a navigator generated by the navigator generation unit 18 (a navigator indicated in information about the generated navigator input from the navigator generation unit 18) in the virtual space at a timing when information indicating that the navigator has been generated from the navigator generation unit 18 has been input. The virtual space in which the mechanism is installed by the field installation unit 19 may be displayed on an interface of the user of the behavior change apparatus 1.

The field installation unit 19 may install a mechanism in the virtual space for each user (individual) in accordance with a generation result of the mechanism decision unit 11. As described above, the mechanism may include (guidance of) a movement mechanism and (guidance of) a navigator. In the field installation unit 19, the navigator may not be installed (or the guidance may not be provided) in the case of a user who is prompted to change behavior without the guidance of the navigator.

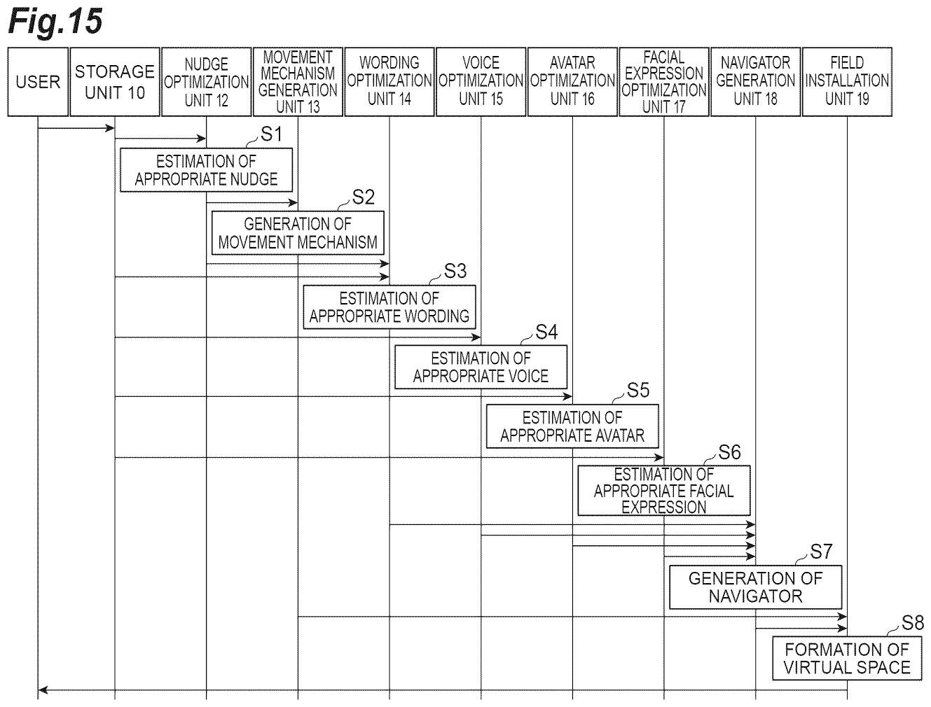

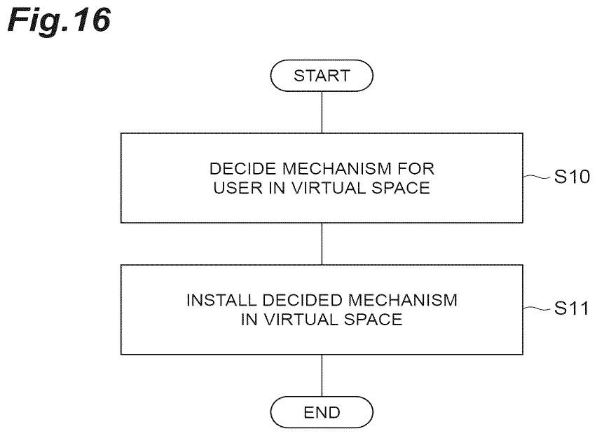

Next, an example of a process executed by the behavior change apparatus 1 will be described with reference to FIGS. 15 and 16.

FIG. 15 is a sequence diagram showing an example of a process executed by the behavior change apparatus according to the embodiment. First, the behavior change apparatus 1 generates cognitive bias information on the basis of the user (e.g., on the basis of a questionnaire response by the user) and the storage unit 10 stores the cognitive bias information. Subsequently, the nudge optimization unit 12 (or the mechanism decision unit 11) estimates an appropriate nudge on the basis of the cognitive bias information stored by the storage unit 10 (step S1). Subsequently, the movement mechanism generation unit 13 (or the mechanism decision unit 11) generates a movement mechanism on the basis of an estimation result of S1 (step S2). Subsequently, the wording optimization unit 14 (or the mechanism decision unit 11) estimates appropriate wording on the basis of the estimation result in S1 and the cognitive bias information stored by the storage unit 10 (step S3). Subsequently, the voice optimization unit 15 (or the mechanism decision unit 11) performs appropriate voice estimation on the basis of the cognitive bias information stored by the storage unit 10 (step S4). Subsequently, the avatar optimization unit 16 (or the mechanism decision unit 11) estimates an appropriate avatar (guiding avatar) on the basis of the cognitive bias information stored by the storage unit 10 (step S5). Subsequently, the facial expression optimization unit 17 (or the mechanism decision unit 11) estimates an appropriate facial expression on the basis of the cognitive bias information stored by the storage unit 10 (step S6).

Subsequently, the navigator generation unit 18 (or the mechanism decision unit 11) generates a navigator on the basis of an estimation result of step S3, an estimation result of step S4, an estimation result of step S5, and an estimation result of step S6 (step S7). Subsequently, the field installation unit 19 forms a virtual space in which the movement mechanism generated in step S2 and the navigator generated in step S7 are installed (step S8) and outputs (displays) the virtual space to the user.

In the sequence diagram of FIG. 15, step S1 may be performed at any time before steps S2 and S3. Step S2 may be performed at any time after step S1 and before step S8. Step S3 may be performed at any time after step S1 and before step S7. Steps S4 to S6 may be performed at any time before step S7. Step S7 may be performed at any time after steps S3 to S6. Step S8 may be performed at any time after steps S2 and S7.

FIG. 16 is a flowchart showing an example of a process executed by the behavior change apparatus 1 according to the embodiment. First, the mechanism decision unit 11 decides a mechanism for the user in the virtual space on the basis of the user's cognitive bias (step S10). Subsequently, the field installation unit 19 installs the mechanism decided in S10 in the virtual space (step S11).

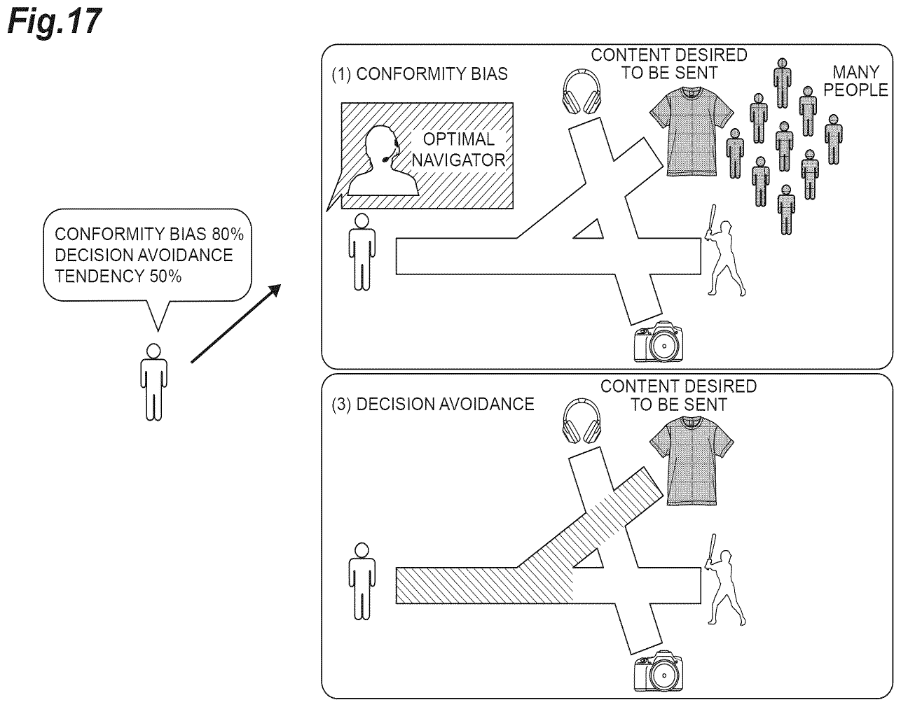

FIG. 17 is a diagram showing an example in which an optimal mechanism is selected on the basis of an individual's cognitive bias. As shown in FIG. 17, when a conformity bias that is a cognitive bias of a certain individual (user) is 80% and decision avoidance tendency that is a cognitive bias is 50%, the behavior change apparatus 1 selects a mechanism based on a higher degree of conformity bias.

Next, the operation and effects of the behavior change apparatus 1 according to the embodiment will be described.

According to the behavior change apparatus 1, the mechanism decision unit 11 decides a mechanism for the user in the virtual space on the basis of the user's cognitive bias and the field installation unit 19 installs the mechanism decided by the mechanism decision unit 11 in the virtual space. According to this configuration, because a mechanism for the user is installed in the virtual space, it is possible to prompt the user to change behavior in the virtual space.

Moreover, according to the behavior change apparatus 1, the mechanism decision unit 11 may decide a mechanism using a prediction model for predicting a degree of change in behavior of the user from the mechanism by inputting the degree of the cognitive bias of the user. According to this configuration, because it is possible to install a mechanism based on a degree of behavior change predicted by a prediction model, it is possible to more reliably prompt a user to change behavior.

Moreover, according to the behavior change apparatus 1, the mechanism may be a mechanism for guiding the user to predetermined content located in the virtual space. According to this configuration, the user can be guided to the predetermined content located in the virtual space.

Moreover, according to the behavior change apparatus 1, the mechanism decision unit 11 may decide a mechanism further on the basis of the user's attributes. According to this configuration, it is possible to more reliably prompt the user to change behavior based on his or her attributes.

Moreover, according to the behavior change apparatus 1, the mechanism may comprise a mechanism related to a virtual movement of the user in the virtual space (a movement mechanism). According to this configuration, it is possible to guide the user to move virtually in the virtual space. For example, it is possible to guide the user to content located in the virtual space.

Moreover, according to the behavior change apparatus 1, the mechanism may comprise a mechanism related to the guidance for the user from a predetermined avatar (guiding avatar) in the virtual space. According to this configuration, because the user can be guided by the guiding avatar, it is possible to more reliably prompt the user to change behavior.

Moreover, according to the behavior change apparatus 1, at least one item of wording emitted by the avatar during guidance, voice emitted by the avatar during guidance, an appearance of an avatar (guiding avatar), and a facial expression of the avatar during guidance may be based on the user's cognitive bias. According to this configuration, because the user can be guided by a guiding avatar more suitable for the user based on the user's cognitive bias, it is possible to more reliably prompt the user to change behavior.

According to the behavior change apparatus 1, for example, it is possible to implement a process in which a user changes behavior through guidance optimization in a metaverse.

The background is that the metaverse is attracting attention amid the COVID-19 pandemic. Because the virtual world is not restricted by a location and time, it is possible to install various content compared to the real world. Content is a store for economic activities, a facility for entertainment, or the like. In the virtual world, guiding an appropriate user to appropriate content (behavior change) can bring benefits to both a user and a producer. A simple means is guidance based on messaging. In even similar content guidance, depending on a method or way of conveying content, a person who communicates, and a tone of voice (a frequency, intensity, or volume), a method or way of receiving or understanding content and motivation for action vary from individual to individual. These are considered to depend on individual attributes and cognitive biases.

As a challenge, there is a possibility that consumers and producers will not match due to content saturation. More than simple messaging alone is needed to achieve a behavior change effect, and a combination of various technologies can be expected to maximize the behavior change effect. Although automatic avatar (image) and voice generation technology and machine learning estimation technology based on generative adversarial networks (GANs) have been established, there are no application examples for the purpose of behavior change. Although more effective behavior change effects can be expected by combining the above-described technology with messaging based on behavioral economics, the technology and structure thereof still need to be established.

The behavior change apparatus 1 installs a mechanism linked to a cognitive bias in the virtual world when people are guided to specific content. The behavior change apparatus 1 selects an optimal mechanism on the basis of the cognitive bias of the individual. The behavior change apparatus 1 individually optimizes each element in navigation (or estimates each element in navigation from attributes and cognitive biases). Specifically, content of a message (a method or way of conveying the message), a tone of voice (a frequency, intensity, or volume), an avatar (an appearance of a speaker), and a facial expression are included. The behavior change apparatus 1 provides a preset for the above and selects the most suitable one. Voice tones and avatars may be automatically generated by the GAN instead of a preset (a modified example). The behavior change apparatus 1 does not necessarily need to include all elements of voice guidance.

The behavior change apparatus 1 has a system for providing mechanisms linked to cognitive biases such as installing a group of NPCs and making a specific route conspicuous in the virtual world and distributing the mechanism for each individual in accordance with the cognitive bias of the individual user. The behavior change apparatus 1 has a system for optimizing message content, an appearance of a speaker (an avatar), the voice of the speaker, and a facial expression of the speaker in the navigation of the virtual world so that an individual is prompted to change behavior in units of individuals on the basis of a cognitive bias and further guiding the individual to specific content with an optimal means through navigating. The behavior change apparatus 1 may not perform navigation depending on the user.

The behavior change apparatus 1 of the present disclosure has the following configuration.

[1] A behavior change apparatus comprising:
a decision unit configured to decide a mechanism for a user in a virtual space on the basis of a cognitive bias of the user; and
an installation unit configured to install the mechanism decided by the decision unit in the virtual space.

[2] The behavior change apparatus according to [1], wherein the decision unit decides the mechanism using a prediction model for predicting a degree of change in behavior of the user from the mechanism by inputting a degree of the cognitive bias of the user.

[3] The behavior change apparatus according to [1] or [2], wherein the mechanism is a mechanism for guiding the user to predetermined content located in the virtual space.

[4] The behavior change apparatus according to any one of [1] to [3], wherein the decision unit decides the mechanism further on the basis of an attribute of the user.

[5] The behavior change apparatus according to any one of [1] to [4], wherein the mechanism comprises a mechanism related to virtual movement of the user in the virtual space.

[6] The behavior change apparatus according to any one of [1] to [5], wherein the mechanism comprises a mechanism related to guidance for the user using a predetermined avatar in the virtual space.

[7] The behavior change apparatus according to [6], wherein at least one item of wording emitted by the avatar during the guidance, voice emitted by the avatar during the guidance, an appearance of the avatar, and a facial expression of the avatar during the guidance is based on the cognitive bias of the user.

Also, the block diagrams used to describe the above embodiments show blocks in functional units. These functional blocks (components) are implemented by any combination of at least one of hardware and software. Moreover, the method of implementing each functional block is not particularly limited. That is, each functional block may be implemented using one apparatus physically or logically coupled or may be implemented by directly or indirectly connecting two or more physically or logically separated apparatuses (e.g., using a wired type, a wireless type, or the like) and using these apparatuses. A functional block may be implemented by combining software in the one or more apparatuses described above.

Although functions include judging, deciding, determining, calculating, producing, processing, deriving, examining, searching, checking, receiving, transmitting, outputting, accessing, resolving, selecting, choosing, establishing, comparing, assuming, expecting, regarding, broadcasting, notifying, communicating, forwarding, configuring, reconfiguring, allocating, mapping, assigning, and the like, the present disclosure is not limited thereto. For example, a functional block (component) that performs transmission is called a transmitting unit or transmitter. In either case, as described above, the implementation method is not particularly limited.

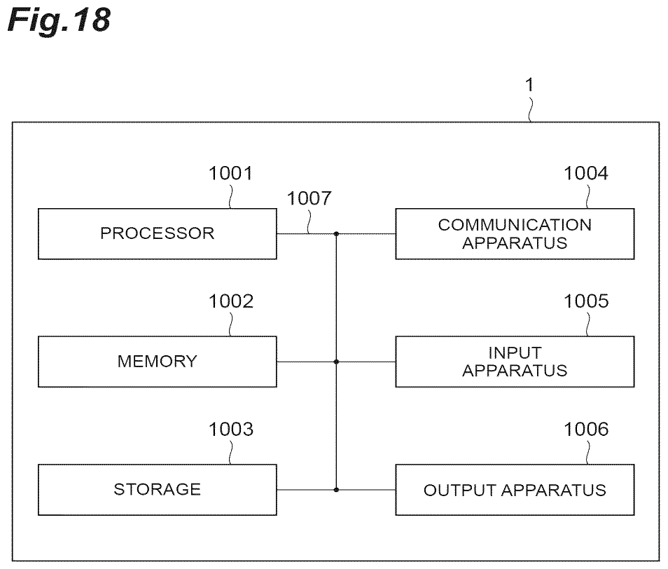

For example, the behavior change apparatus 1 or the like in an embodiment of the present disclosure may function as a computer that performs a process of a behavior change method of the present disclosure. FIG. 18 is a diagram showing an example of a hardware configuration of the behavior change apparatus 1 according to the embodiment of the present disclosure. The behavior change apparatus 1 described above may be physically configured as a computer apparatus including a processor 1001, a memory 1002, a storage 1003, a communication apparatus 1004, an input apparatus 1005, an output apparatus 1006, a bus 1007, and the like.

Also, in the following description, the term “apparatus” can be read as a circuit, a unit, or the like. The hardware configuration of the behavior change apparatus 1 may be configured to include one or more of the apparatuses shown in the drawings, or may be configured without some apparatuses.

Each function in the behavior change apparatus 1 is implemented by causing hardware such as the processor 1001 and the memory 1002 to read predetermined software (program), to perform a calculation process of the processor 1001, to control communication by the communication apparatus 1004, or to control at least one of a data reading process and a data writing process in the memory 1002 and the storage 1003.

The processor 1001, for example, operates an operating system to control the entire computer. The processor 1001 may include a central processing unit (CPU) including interfaces with peripheral apparatuses, control apparatuses, calculation apparatuses, registers, and the like. For example, the mechanism decision unit 11, the nudge optimization unit 12, the movement mechanism generation unit 13, the wording optimization unit 14, the voice optimization unit 15, the avatar optimization unit 16, the facial expression optimization unit 17, the navigator generation unit 18, the field installation unit 19, and the like may be implemented by the processor 1001.

Moreover, the processor 1001 reads programs (program codes), software modules, and data from at least one of the storage 1003 and the communication apparatus 1004 to the memory 1002 and performs various types of processes in accordance therewith. For the program, a program that causes a computer to execute at least a portion of the operation described in the above-described embodiments is used. For example, the mechanism decision unit 11, the nudge optimization unit 12, the movement mechanism generation unit 13, the wording optimization unit 14, the voice optimization unit 15, the avatar optimization unit 16, the facial expression optimization unit 17, the navigator generation unit 18, and the field installation unit 19 may be stored in the memory 1002 and implemented by a control program that operates in the processor 1001 and the other functional blocks may be similarly implemented. While the various types of processes described above have been described as being executed by one processor 1001, they may be executed simultaneously or sequentially by two or more processors 1001. The processor 1001 may be implemented by one or more chips. Also, the program may be transmitted from the network via a telecommunications circuit.

The memory 1002 is a computer-readable recording medium, and may include, for example, at least one of a read only memory (ROM), an erasable programmable ROM (EPROM), an electrically erasable programmable ROM (EEPROM), and a random-access memory (RAM). The memory 1002 may also be referred to as a register, a cache, a main memory (a main storage apparatus), or the like. The memory 1002 is capable of storing programs (program codes), software modules, and the like capable of being executed to perform a wireless communication method according to an embodiment of the present disclosure.

The storage 1003 is a computer-readable storage medium. The storage 1003 may include, for example, at least one of an optical disc, such as a compact disc ROM (CD-ROM), a hard disk drive, a flexible disk; an optical magnetic disk (e.g., a compact disc, a digital versatile disc, or a Blu-ray (registered trademark) disc), a smart card; a flash memory (e.g., a card, a stick, or a key drive), a floppy (registered trademark) disk, a magnetic strip, or the like. The storage 1003 may be referred to as an auxiliary memory apparatus. The above-described storage medium may be, for example, a database including at least one of the memory 1002 and the storage 1003, a server, or another suitable medium.

The communication apparatus 1004 is hardware (a transceiver device) for performing communication between computers via at least one of a wired network and a wireless network. The communication apparatus 1004 is also referred to, for example, as a network device, a network control unit, a network card, a communication module, or the like. The communication apparatus 1004 may be configured to include a high-frequency switch, a duplexer, a filter, a frequency synthesizer, or the like to implement, for example, at least one of frequency division duplex (FDD) and time division duplex (TDD). For example, the mechanism decision unit 11, the nudge optimization unit 12, the movement mechanism generation unit 13, the wording optimization unit 14, the voice optimization unit 15, the avatar optimization unit 16, the facial expression optimization unit 17, the navigator generation unit 18, and the field installation unit 19 described above may be implemented by the communication apparatus 1004.

The input apparatus 1005 is an input device (e.g., a keyboard, a mouse, a microphone, a switch, a button, a sensor, or the like) that receives an external input. The output apparatus 1006 is an output device (e.g., a display, a speaker, an LED lamp, or the like) that externally provides an output. Also, the input apparatus 1005 and the output apparatus 1006 may have an integrated configuration (e.g., a touch panel).

Moreover, apparatuses such as the processor 1001 and the memory 1002 are connected by the bus 1007 for communicating information. The bus 1007 may be configured using a single bus or may be configured using different buses between the apparatuses.

Moreover, the behavior change apparatus 1 may be configured to include hardware such as a microprocessor, a digital signal processor (DSP), an application-specific integrated circuit (ASIC), a programmable logic device (PLD), and a field programmable gate array (FPGA), and some or all functional blocks may be implemented by the hardware. For example, the processor 1001 may be implemented by at least one of the above-described pieces of hardware.

An information notification is not limited to an aspect/embodiment described in the present disclosure and may be provided using other methods.

Each of the above aspects/embodiments may be applied to at least one of long term evolution (LTE), LTE-advanced (LTE-A), SUPER 3G, IMT-Advanced, 4^{th} generation mobile communication system (4G), 5^{th} generation mobile communication system (5G), future radio access (FRA), new radio (NR), W-CDMA (Registered Trademark), GSM (Registered Trademark), CDMA2000, ultra mobile broadband (UMB), IEEE 802.11 (Wi-Fi (Registered Trademark)), IEEE 802.16 (WiMAX (Registered Trademark)), IEEE 802.20, ultra-wideband (UWB), Bluetooth (Registered Trademark), a system using any other appropriate system, and a next-generation system that is expanded based thereon. Moreover, a combination of a plurality of systems (e.g., a combination of at least one of the LTE and the LTE-A with the 5G or the like) may be applied.

The processing procedure, sequence, flowchart, and the like of the aspects/embodiments described in the present disclosure may be performed in a different order as long as no contradiction is incurred. For example, for a method described in the present disclosure, elements of various apparatuses are described in illustrative order, and the described order is not limited to the specific order.

Input or output information and the like may be stored in a predetermined location (e.g., a memory) or may be managed using a management table. Input or output information and the like can be overwritten or updated, or information may be added thereto. Output information and the like may be deleted. Input information and the like may be transmitted to another apparatus.

Determination may be made by a value represented by one bit (0 or 1), may be made by a Boolean value (Boolean: true or false), or may be made by comparison of numerical values (e.g., comparison with a predetermined value).

Each aspect/embodiment described in the present disclosure may be used alone; may be combined to be used; or may be switched in accordance with execution. Furthermore, the notification of predetermined information (e.g., the notification indicating that “it is X”) is not limited to the notification that is made explicitly; and the notification may be made implicitly (e.g., the notification of the predetermined information is not performed).

Although the present disclosure has been described in detail above, it is clear to those skilled in the art that the present disclosure is not limited to the embodiments described in the present disclosure. The present disclosure can be practiced with modifications and variations without departing from the spirit and scope of the present disclosure as defined by the claims. Accordingly, the description of the present disclosure is for illustrative purposes and is not meant to be limiting in any way.

Regardless of whether software is referred to as software, firmware, middleware, microcode, hardware description language, or another name, the software should be interpreted broadly so as to imply a command, a command set, a code, a code segment, a program code, a program, a subprogram, a software module, an application, a software application, a software package, a routine, a subroutine, an object, an executable file, an execution thread, a procedure, a function, and the like.

Moreover, software, a command, information, and the like may be transmitted and received via a transmission medium. For example, when the software is transmitted from a Web site, a server, or another remote source using at least one of wired technology (such as a coaxial cable, an optical fiber cable, a twisted pair, and a digital subscriber line (DSL)) and wireless technology (such as infrared, radio, and microwave), at least one of the wired technology and wireless technology is included within the definition of the transmission medium.

Information, signals, or the like described in the present disclosure may be represented by using any of a variety of different technologies. For example, data, an instruction, a command, information, a signal, a bit, a symbol, a chip, or the like that may be mentioned throughout the above description may be represented by a voltage, a current, electromagnetic waves, a magnetic field, a magnetic particle, an optical field, photons, or a desired combination thereof.

The terms described in the present disclosure and terms necessary for understanding the present disclosure may be replaced by terms having the same or similar meanings.

The terms “system” and “network” used in the present disclosure are used interchangeably.

Also, the information, parameters, and the like, which are described in the present disclosure, may be represented by absolute values, may be represented as relative values from predetermined values, or may be represented by any other corresponding information.

The name used for the above parameter is not restrictive in any respect. Furthermore, formulas and the like using these parameters may be different from those explicitly disclosed in the present disclosure.

The terms “determining” and “deciding” used in the present disclosure may include various types of operations. For example, “determining” and “deciding” may include deeming that a result of judging, calculating, computing, processing, deriving, investigating, looking up, search, and inquiry (e.g., search in a table, a database, or another data structure), or ascertaining is determined or decided. Moreover, “determining” and “deciding” may include, for example, deeming that a result of receiving (e.g., reception of information), transmitting (e.g., transmission of information), input, output, or accessing (e.g., accessing data in memory) is determined or decided. Moreover, “determining” and “deciding” may include deeming that a result of resolving, selecting, choosing, establishing, or comparing is determined or decided. Moreover, “determining” and “deciding” may include deeming that some operation is determined or decided. Moreover, “determining (deciding)” may be read as “assuming,” “expecting,” “considering,” or the like.

The terms “connected,” “coupled,” or any variation thereof, mean any direct or indirect connection or coupling between two or more elements and can include the presence of one or more intermediate elements between two elements being “connected” or “coupled.” Couplings or connections between elements may be physical, logical, or a combination thereof. For example, “connection” may be read as “access.” As used in the present disclosure, two elements are defined to be “connected” or “coupled” to each other using at least one of one or more wires, cables, and printed electrical connections and, as some non-limiting and non-exhaustive examples, in the radio frequency domain, electromagnetic energy having wavelengths in the microwave and optical (both visible and invisible) regions, and the like.

The expression “on the basis of” used in the present specification does not mean “on the basis of only” unless otherwise stated particularly. In other words, the expression “on the basis of” means both “on the basis of only” and “on the basis of at least.”

Any reference to elements using names, such as “first” and “second,” which are used in the present disclosure, does not generally limit the quantity or order of these elements. These names are used in the present disclosure as a convenient method for distinguishing two or more elements. Accordingly, the reference to the first and second elements does not imply that only the two elements can be adopted here, or does not imply that the first element must precede the second element in any way.

The term “means” in the configuration of each apparatus described above may be replaced with a term such as “unit,” “circuit,” or “device.”

As long as “include,” “including,” and the variations thereof are used in the present disclosure, these terms are intended to be inclusive, similar to the term “comprising.” Furthermore, it is intended that the term “or” used in the present disclosure is not “exclusive OR.”

In the present disclosure, if articles, such as a, an, and the in English, are added according to translation, the present disclosure may include that the nouns following these articles have plural forms.

In the present disclosure, the term “A and B are different” may mean “A and B are different from each other.” The term may also mean that “A and B are different from C.” The terms such as “separate,” “coupled,” and the like may also be interpreted like the term “different.”

### REFERENCE SIGNS LIST

1 . . . Behavior change apparatus, 10 . . . Storage unit, 11 Mechanism decision unit, 12 . . . Nudge optimization unit, 13 . . . Movement mechanism generation unit, 14 . . . Wording optimization unit, 15 . . . Voice optimization unit, 16 . . . Avatar optimization unit, 17 . . . Facial expression optimization unit, 18 . . . Navigator generation unit, 19 . . . Field installation unit, 1001 . . . Processor, 1002 . . . Memory, 1003 . . . Storage, 1004 . . . Communication apparatus, 1005 Input apparatus, 1006 Output apparatus, 1007 . . . Bus.

1. A behavior change apparatus comprising processing circuitry configured to:
decide a mechanism for a user in a virtual space on the basis of a cognitive bias of the user; and
install the decided mechanism in the virtual space.

2. The behavior change apparatus according to claim 1, wherein the processing circuitry is configured to decide the mechanism using a prediction model for predicting a degree of change in behavior of the user from the mechanism by inputting a degree of the cognitive bias of the user.

3. The behavior change apparatus according to claim 1, wherein the mechanism is a mechanism for guiding the user to predetermined content located in the virtual space.

4. The behavior change apparatus according to claim 1, wherein the processing circuitry is configured to decide the mechanism further on the basis of an attribute of the user.

5. The behavior change apparatus according to claim 1, wherein the mechanism comprises a mechanism related to virtual movement of the user in the virtual space.

6. The behavior change apparatus according to claim 1, wherein the mechanism comprises a mechanism related to guidance for the user using a predetermined avatar in the virtual space.

7. The behavior change apparatus according to claim 6, wherein at least one item of wording emitted by the avatar during the guidance, voice emitted by the avatar during the guidance, an appearance of the avatar, and a facial expression of the avatar during the guidance is based on the cognitive bias of the user.

8. The behavior change apparatus according to claim 5, wherein the mechanism comprises a mechanism related to guidance for the user using a predetermined avatar in the virtual space.
